(19) United States
(12) Patent Application Publication
(10) Pub. No.: US 2018/0070761 A1
(43) Pub. Date: Mar. 15, 2018

(54) PORTABLE BLENDING SLEEVE FOR A FOOD PROCESSOR

(71) Applicant: Vela Blend, Inc., Gilbert, AZ (US)

(72) Inventors: Matthew Sedlacek, Gilbert, AZ (US); Joseph Velasquez, Scottsdale, AZ (US); Angie Nguyen, Tempe, AZ (US); Robert Fulbright, Mesa, AZ (US); Jacob Petersen, Phoenix, AZ (US); Richard Chover, Wildomar, CA (US)

(21) Appl. No.: 15/261,589

(22) Filed: Sep. 9, 2016

(51) Int. Cl. A47J 31/44; B01F 15/00; A47J 43/27; B65D 21/02

(52) U.S. Cl. CPC A47J 31/4403; B01F 15/00876; B01F 15/00993; B01F 2215/0022; A47J 43/27; B65D 21/0209; B01F 15/00155

(57) ABSTRACT

Providing a portable blending sleeve for a food processor can include forming one or more structures of the blending sleeve that enable coupling of the blending sleeve with the food processor; and forming one or more structures of the blending sleeve that enable the food processor to blend a set of ingredients inside the blending sleeve.

### BACKGROUND

A food processor can include a blending carafe for blending a variety of food ingredients. A user of a food processor can shop for the desired food ingredients, measure out and add the food ingredients into the blending carafe, and then attach the blending carafe to the food processor. Once blended, the user can pour the blended food ingredients into a drinking cup and clean the food processor.

### SUMMARY

In general, in one aspect, the invention relates to a portable blending sleeve for a food processor. The blending sleeve can include: one or more structures formed in the blending sleeve that enable coupling of the blending sleeve with the food processor; and one or more structures formed in the blending sleeve that enable the food processor to blend a set of ingredients inside the blending sleeve.

In general, in another aspect, the invention relates to a method for providing a portable blending sleeve for a food processor. The method can include: forming one or more structures of the blending sleeve that enable coupling of the blending sleeve with the food processor; and forming one or more structures of the blending sleeve that enable the food processor to blend a set of ingredients inside the blending sleeve.

Other aspects of the invention will be apparent from the following description and the appended claims.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 shows a lip and a set of ribs formed in a blending sleeve in one or more embodiments.

FIG. 2 is a close-up illustration of a lip formed in a blending sleeve in one or more embodiments.

FIG. 3 is an exploded view showing a lid and an airtight seal in one or more embodiments of a blending sleeve.

FIG. 4 is a perspective view showing how an open space provided by an airtight seal of a blending sleeve provides space for a stack of additional blending sleeves.

FIG. 5 shows an airtight seal that provides an open space inside a blending sleeve for accommodating a set of additional ingredients.

FIG. 6 shows how an open space provided by an airtight seal of a blending sleeve provides space for a stack of additional blending sleeves while accommodating additional ingredients.

FIG. 7 is a cut-away top view showing a set of ribs formed vertically in a peripheral wall of a blending sleeve and a set of corresponding structures of a food processor.

FIG. 8 shows an insert for shielding ingredients to be blended from direct contact with the plastic structure of a blending sleeve.

FIG. 9 shows a blending sleeve being coupled with a blending carafe of a food processor in one or more embodiments.

FIG. 10 is a cross-sectional view of a single-wall arrangement of a peripheral wall of a blending sleeve in one or more embodiments.

FIG. 11 is a cross-sectional view of a multiple-wall arrangement of a peripheral wall of a blending sleeve in one or more embodiments.

FIG. 12 shows structures that enable air to escape from a blending sleeve when a food processor injects a liquid in one or more embodiments.

FIG. 13 shows a pull-tab that facilitates removal of a blending sleeve from a food processor in one or more embodiments.

FIG. 14 shows a set of vents formed in a peripheral wall of a blending sleeve to facilitate removal of the blending sleeve from a food processor in one or more embodiments.

FIGS. 15-16 are perspective and side views of a blending sleeve in one or more embodiments showing an O-ring.

FIGS. 17-18 are side and perspective views of a blending sleeve in one or more embodiments showing a set of indicators of fill levels for ingredients to be blended.

FIG. 19 illustrates a method for providing a portable blending sleeve for a food processor in one or more embodiments.

### DETAILED DESCRIPTION

Reference will now be made in detail to the various embodiments of the present disclosure, examples of which are illustrated in the accompanying drawings. Like elements in the various figures are denoted by like reference numerals for consistency. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, have not been described in detail so as not to unnecessarily obscure aspects of the present disclosure.

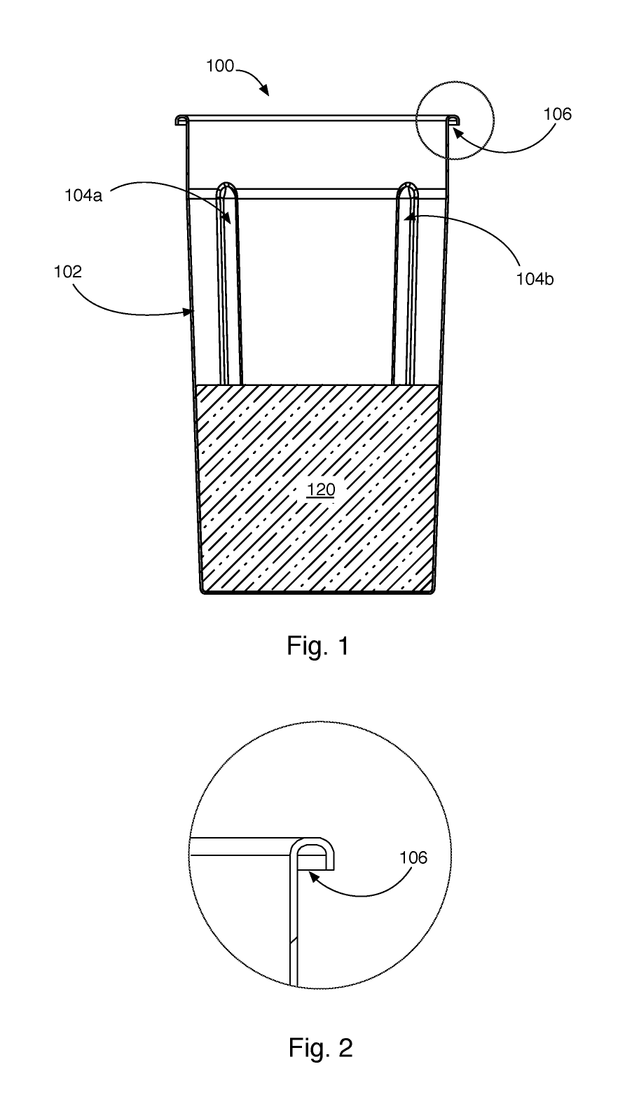

FIGS. 1-18 illustrate a portable blending sleeve 100 for a food processor in one or more embodiments. The blending sleeve 100 enables a blending of a set of ingredients 120 inside the blending sleeve 100 when the blending sleeve 100 is coupled with a food processor. The ingredients 120 can be any food ingredients suitable for blending or mixing, e.g., soups, smoothies, health supplements, etc. The ingredients 120 can be prepackaged inside the blending sleeve 100 or can be added manually by a user.

The blending sleeve 100 can include one or more structures formed in the blending sleeve 100 that enable coupling of the blending sleeve 100 with a food processor. A structure that enables coupling of the blending sleeve 100 with a food processor can include a lip for providing a seal between the blending sleeve 100 and a blending structure, e.g., a blending carafe, a blade attachment, etc., of a food processor. A structure that enables coupling of the blending sleeve 100 with a food processor can include an O-ring for providing a seal between the blending sleeve 100 and a blending structure, e.g., a blending carafe, a blade attachment, etc., of a food processor. A structure that enables coupling of the blending sleeve 100 with a food processor can include structures formed in a peripheral wall of the blending sleeve 100 for fitting the blending sleeve 100 to corresponding structures formed in a blending structure, e.g., a blending carafe, of a food processor. A structure that enables coupling of the blending sleeve 100 with a food processor can include a set of threads for attaching the blending sleeve 100 to a food processor via a corresponding set of threads of the food processor, e.g., via threads of a blending carafe, blade attachment, etc., of a food processor.

The blending sleeve 100 can include one or more structures formed in the blending sleeve 100 that enable a food processor to blend the ingredients 120 inside the blending sleeve 100. A structure that enables a food processor to blend the ingredients 120 inside the blending sleeve 100 can include a turbulent structure, e.g., one or more ribs, formed in a peripheral wall of the blending sleeve 100. A structure that enables a food processor to blend the ingredients 120 inside the blending sleeve 100 can include a non-stick surface formed inside the blending sleeve 100. A structure that enables a food processor to blend the ingredients 120 inside the blending sleeve 100 can include one or more structures for allowing air to escape from the blending sleeve 100 when a liquid is injected into the blending sleeve 100 by a food processor.

The blending sleeve 100 can include one or more structures formed in the blending sleeve 100 that facilitate removal of the blending sleeve 100 from a food processor. A structure that facilitates removal of the blending sleeve 100 from a food processor can include a pull-tab formed, e.g., at a top of the blending sleeve 100. A structure that facilitates removal of the blending sleeve 100 from a food processor can include a structure that prevents formation of a vacuum force between the blending sleeve 100 and a food processor, e.g., between the blending sleeve 100 and a blending carafe of the food processor.

The blending sleeve 100 can be formed of a thin plastic material so that it is disposable. The blending sleeve 100 can be formed of a relatively thick plastic material or a stainless steel material so that it is reusable. The blending sleeve 100 can have a single-wall or multiple-wall arrangement.

The ingredients 120, e.g., freeze dried ingredients, can be prepackaged inside the blending sleeve 100. The ingredients 120 can be added to the blending sleeve 100 by a user, e.g., from prepackaged containers.

In some embodiments, the blending sleeve 100 can be made of a relatively thick material that has a low manufacturing cost so that it can be used as a disposable alternative for a blending carafe of a food processor rather than as a sleeve for the blending carafe.

FIG. 1 shows a lip 106 formed at the top of the blending sleeve 100 in one or more embodiments. The lip 106 can be adapted for forming a seal with a blending structure, e.g., a blending carafe, a blade attachment, etc., of a food processor. FIG. 2 is a close-up illustration of the lip 106. In some embodiments, the lip 106 can include an O-ring for enhancing a seal with a blending structure of a food processor.

FIG. 1 also shows a set of ribs 104a-b formed in a peripheral wall 102 of the blending sleeve 100 in one or more embodiments. The ribs 104a-b can facilitate blending of the ingredients 120 inside the blending sleeve 100 by acting on a vortex that can form inside the blending sleeve 100 during blending. In some embodiments, the peripheral wall 102 can be formed with a geometric shape, e.g., octagonal, hexagonal, etc., designed to break up a vortex that can form inside the blending sleeve 120 during blending.

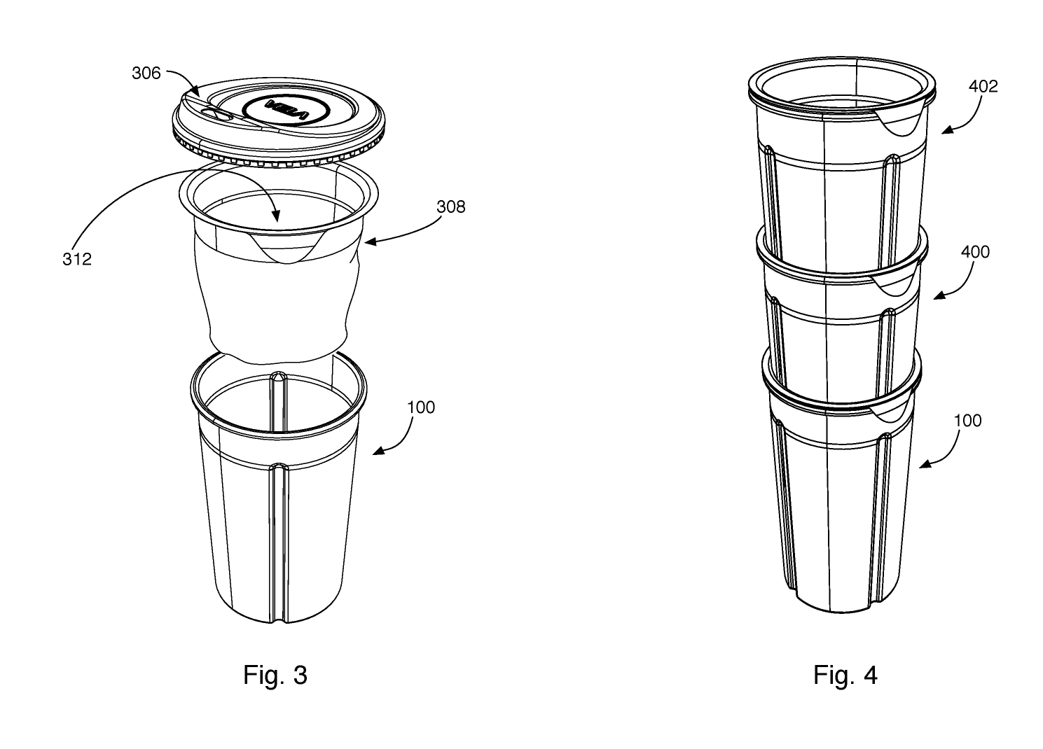

FIG. 3 shows a lid 306, e.g., one adapted for mobile beverage consumption, that can be attached to the top of the blending sleeve 100. For example, the lid 306 can be snapped on to the lip 106 of the blending sleeve 100 or screwed onto a set of threads formed on the blending sleeve 100. After blending, the blending sleeve 100 can be removed from a food processor and the blended contents can be consumed directly from the blending sleeve 100 in a “to go” manner.

FIG. 3 also provides an exploded view of an airtight seal 308 that can be formed over the ingredients 120 in one or more embodiments of the blending sleeve 100. The airtight seal 308 can protect the ingredients 120 prepackaged inside the blending sleeve 100. The airtight seal 308 can provide an open space 312 inside the blending sleeve 100 for accommodating a stack of additional blending sleeves. FIG. 4 is perspective view showing how the open space 312 inside the blending sleeve 100 provides space for a stack of additional blending sleeves 400-402.

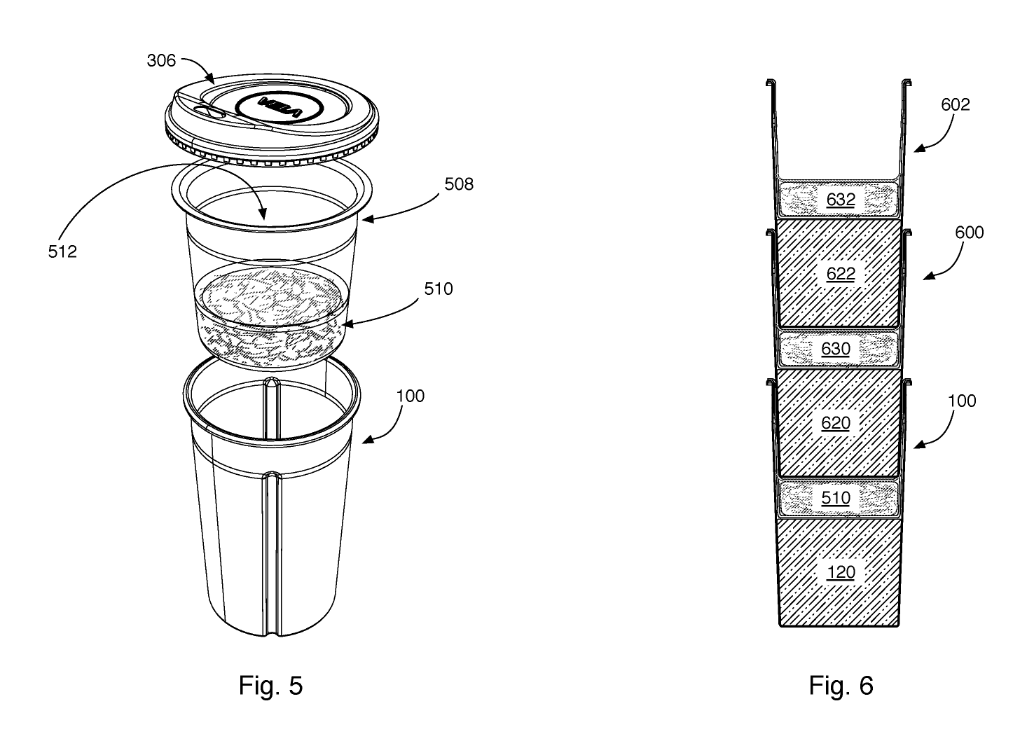

FIG. 5 shows an airtight seal 508 that can be formed over the ingredients 120 in one or more embodiments of the blending sleeve 100. The airtight seal 508 can protect the ingredients 120 prepackaged inside the blending sleeve 100 and provide an open space 512 inside the blending sleeve 100 for accommodating a set of additional ingredients 510 for blending. FIG. 6 shows how the open space 512 inside the blending sleeve 100 provides space for a stack of additional blending sleeves 600-602 while accommodating the additional ingredients 510. Each additional stacked blending sleeve 600-602 includes a respective set of prepackaged ingredients 620-622 and additional ingredients 630-632.

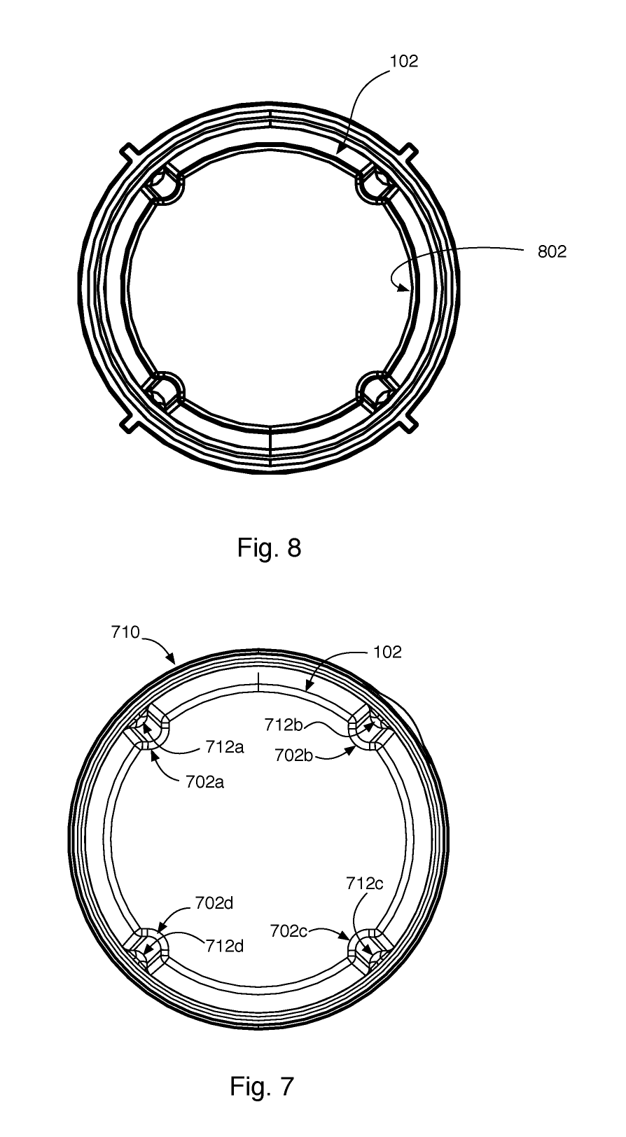

FIG. 7 is a cut-away top view of the blending sleeve 100 showing a set of ribs 702a-d formed vertically in the peripheral wall 102 of the blending sleeve 100. In this embodiment, the ribs 702a-d formed in the peripheral wall 102 of the blending sleeve 100 are designed to seat over a corresponding set of structures 712a-d formed vertically in the inner peripheral wall of a blending carafe 710 of a food processor. For example, the blending carafe 710 can be a stainless steel reusable structure of a food processor so that a user can blend in the blending carafe 710 or insert the blending sleeve 100 inside the blending carafe 710 and blend inside the blending sleeve 100 and take the blended contents to go in the blending sleeve 100 without dirtying the blending carafe 710.

The ribs 702a-d can be formed as indentations in the peripheral wall 102 of the blending sleeve 100. In some embodiments, the ribs 702a-d can be formed to provide a substantially smooth exterior surface of the peripheral wall 102 of the blending sleeve 100.

FIG. 8 shows an embodiment of the blending sleeve 100 that includes an insert 802 for shielding the ingredients 120 from direct contact with the plastic structure of the blending sleeve 100. The insert 802 can be a paper insert.

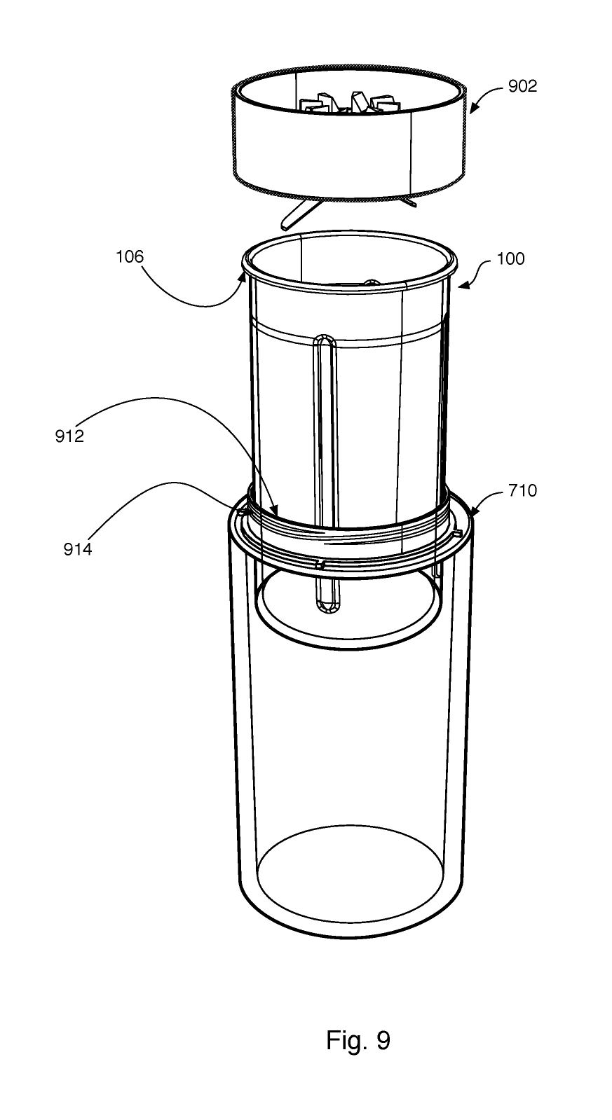

FIG. 9 is a perspective view showing the blending sleeve 100 being coupled with the blending carafe 710 of a food processor and showing how the lip 106 of the blending sleeve 100 interfaces to a rim 912 of the blending carafe 710. Also shown is a blade attachment 902 that attaches to the blending sleeve 100 and the blending carafe 710 via a set of threads 914 of the blending carafe 710.

The blending sleeve 100 can include a set of threads formed beneath the lip 106 for screwing the blending sleeve 100 into a corresponding set of threads in an internal surface of the blending carafe 710.

The blending sleeve 100 can include a set of threads formed beneath the lip 106 for screwing the blade attachment 902 onto the blending sleeve 100.

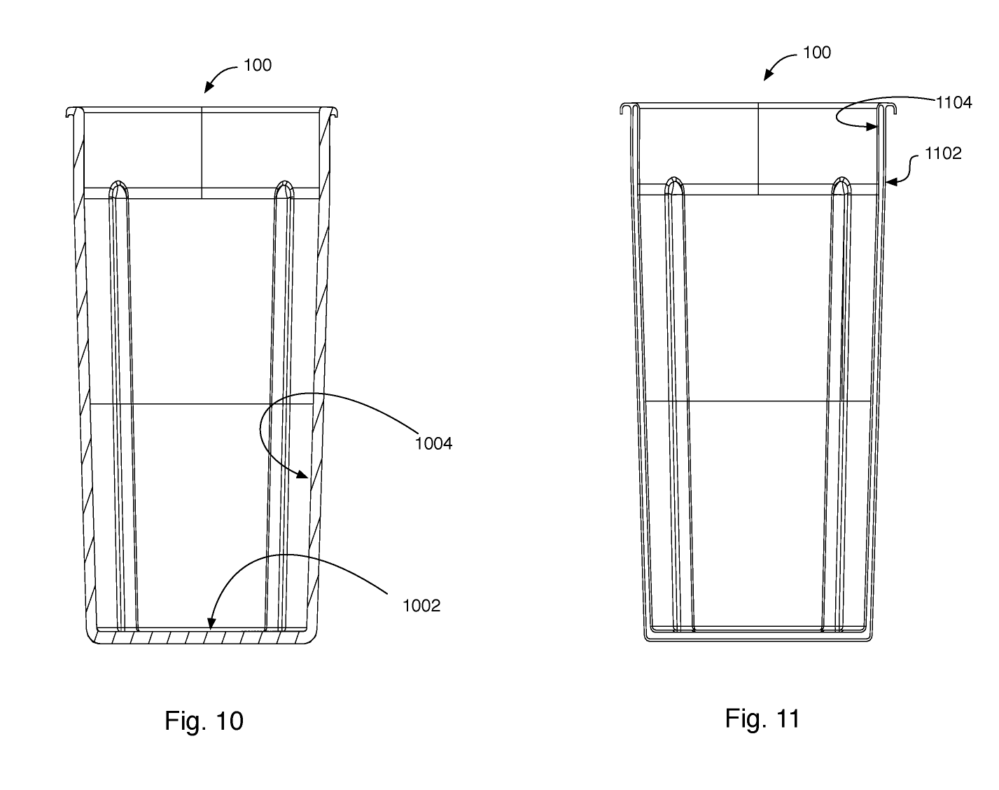

FIG. 10 is a cross-sectional view of a single-wall arrangement of the peripheral wall 102 of the blending sleeve 100. The single-wall can be formed from a plastic or aluminum or other lightweight material. Also shown is a set of non-stick surfaces 1002-1004 formed inside the blending sleeve 100. The non-stick surfaces 1002-1004 can prevent particles of the ingredients 120 from sticking to the blending sleeve 100. The non-stick surfaces 1002-1004 can be coatings of a non-stick material or can be surface textures formed to prevent sticking.

FIG. 11 is a cross-sectional view of a multiple-wall arrangement of the peripheral wall 102 of the blending sleeve 100. The multiple-wall arrangement can prevent the formation of water condensation on the exterior of the blending sleeve 100 and thermally isolate the hot or cold blended contents of the blending sleeve 100. The multiple-wall can be formed from a plastic or aluminum or other lightweight material, and can include a combination with one or more layers of a paper material.

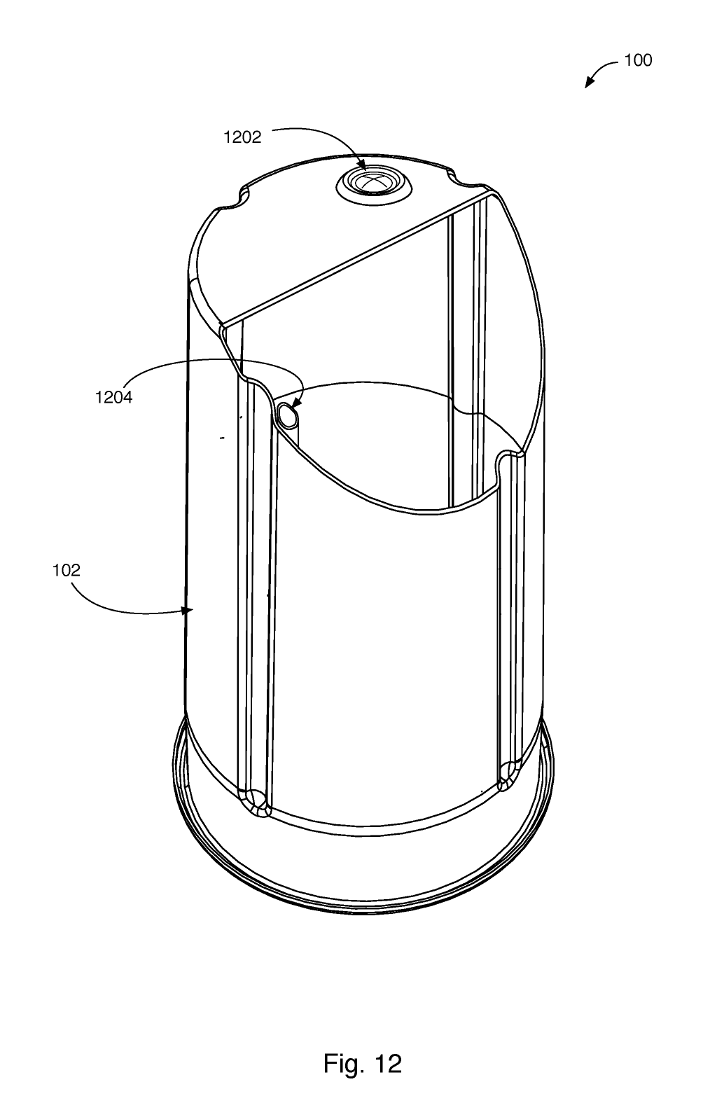

FIG. 12 shows a valve 1202 on the bottom of the blending sleeve 100 in one or more embodiments that enables air to escape from the blending sleeve 100 when a food processor injects a liquid into the blending sleeve 100 or during blending. Also shown is a straw structure 1204 formed in the peripheral wall 102 for allowing airflow vertically through the blending sleeve 100 when a food processor injects a liquid into the blending sleeve 100.

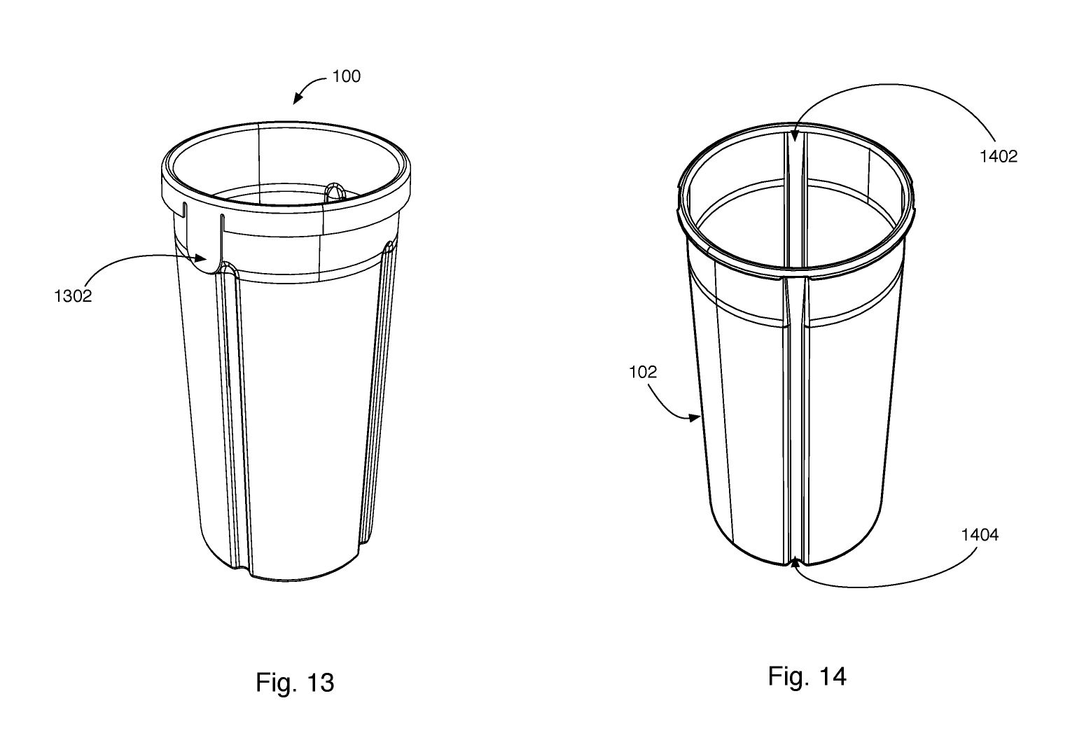

FIG. 13 shows a pull-tab 1302 formed on the blending sleeve 100 in one or more embodiments. The pull-tab 1302 can facilitate removal of the blending sleeve 100 from a food processor, e.g., from the blending carafe 710, by making it easier for a user to pull on the blending sleeve 100.

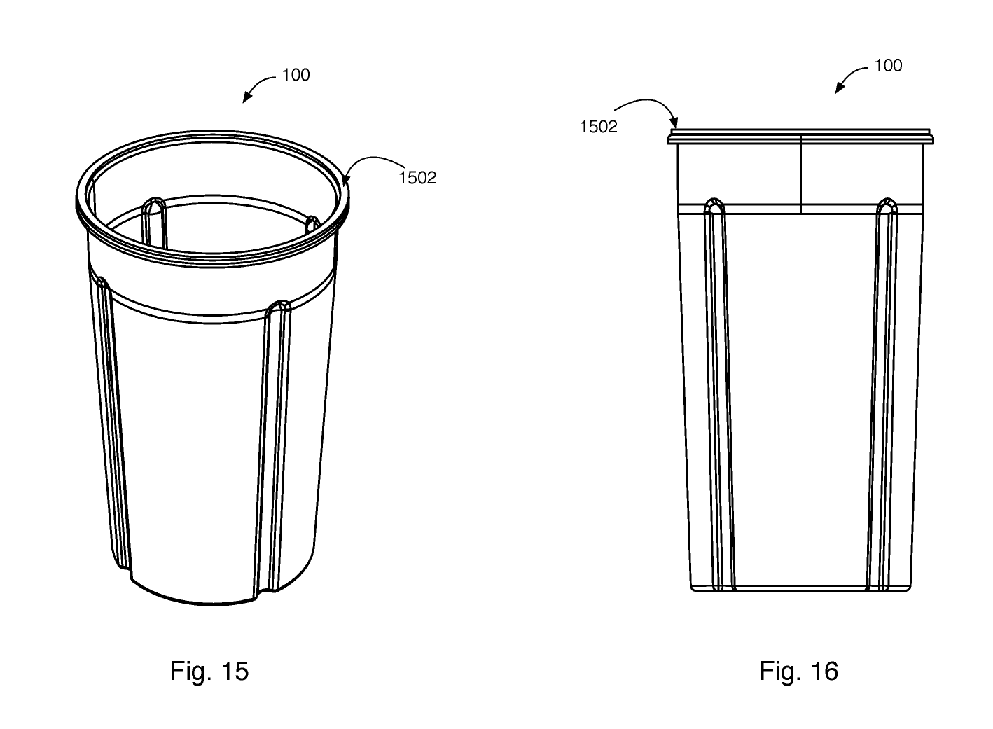

FIG. 14 shows a set of vents 1402-1404 formed in the peripheral wall 102 of the blending sleeve 100 in one or more embodiments. The vents 1402-1404 can facilitate removal of the blending sleeve 100 from a food processor, e.g., from the blending carafe 710, by reducing vacuum forces between the blending sleeve 100 and the food processor, e.g., between the blending sleeve 100 and the interior walls of the blending carafe 710.

FIGS. 15-16 are perspective and side views of the blending sleeve 100 in one or more embodiments having an O-ring 1502 for sealing the blending sleeve 100 to a food processor, e.g. to the blending carafe 710, or the blade attachment 902.

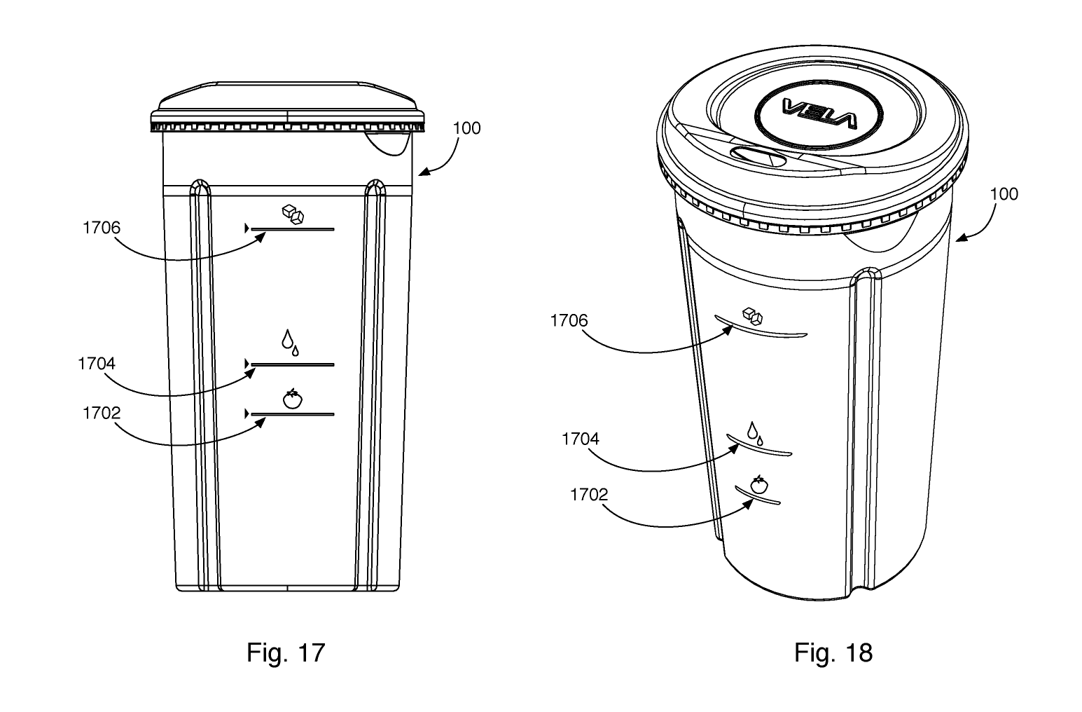

FIGS. 17-18 are side and perspective views of the blending sleeve 100 in one or more embodiments having a set of markings 1702-1706 for indicating to a user respective fill levels for food, water, and ice components, respectively, of the ingredients to be blended inside the blending sleeve 100.

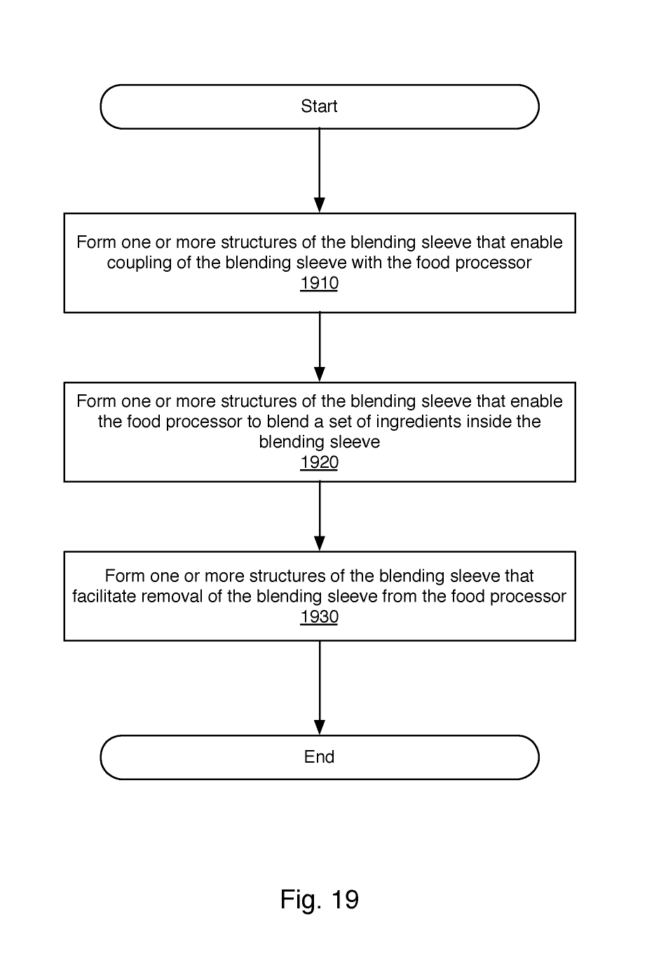

FIG. 19 illustrates a method for providing a portable blending sleeve for a food processor in one or more embodiments. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 19 should not be construed as limiting the scope of the invention.

At step 1910, one or more structures of the blending sleeve are formed that enable coupling of the blending sleeve with a food processor. Examples of structures that can enable coupling of a blending sleeve with a food processor include a lip for providing a seal between a blending sleeve and a food processor, an O-ring for providing a seal between a blending sleeve and a food processor, structures formed in a peripheral wall of a blending sleeve for fitting to corresponding structures formed in a food processor, and threads for attaching a blending sleeved to a food processor.

At step 1920, one or more structures of the blending sleeve are formed that enable a food processor to blend a set of ingredients inside the blending sleeve. Examples of structures that can enable a food processor to blend a set of ingredients inside a blending sleeve include turbulent structures, e.g., one or more ribs, formed in a peripheral wall of a blending sleeve, non-stick surfaces formed inside a blending sleeve, and structures for allowing air to escape from a blending sleeve when a liquid is injected into the blending sleeve by a food processor.

At step 1930, one or more structures of the blending sleeve are formed that facilitate removal of the blending sleeve from the food processor. Examples of structures that can facilitate removal of the blending sleeve from a food processor include pull-tabs, and structures that prevent formation of a vacuum between a blending sleeve and a food processor.

While the foregoing disclosure sets forth various embodiments using specific diagrams, flowcharts, and examples, each diagram component, flowchart step, operation, and/or component described and/or illustrated herein may be implemented, individually and/or collectively, using a range of processes and components.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While the invention has been described with respect to a limited number of embodiments, those skilled in the art, having benefit of this disclosure, will appreciate that other embodiments may be devised which do not depart from the scope of the invention as disclosed herein.

What is claimed is:

1. A blending sleeve for a food processor, comprising:
at least one structure formed in the blending sleeve that enables coupling of the blending sleeve with the food processor; and
at least one structure formed in the blending sleeve that enables the food processor to blend a set of ingredients inside the blending sleeve.

2. The blending sleeve of claim 1, wherein the structure that enables coupling of the blending sleeve with the food processor comprises a lip for providing a seal between the blending sleeve and the food processor.

3. The blending sleeve of claim 1, wherein the structure that enables coupling of the blending sleeve with the food processor comprises an O-ring for providing a seal between the blending sleeve and the food processor.

4. The blending sleeve of claim 1, wherein the structure that enables coupling of the blending sleeve with the food processor comprises at least one structure formed in a peripheral wall of the blending sleeve for fitting the blending sleeve to a corresponding structure formed in the food processor.

5. The blending sleeve of claim 1, wherein the structure that enables coupling of the blending sleeve with the food processor comprises a set of threads for attaching the blending sleeve to the food processor via a corresponding set of threads of the food processor.

6. The blending sleeve of claim 1, wherein the structure that enables the food processor to blend a set of ingredients inside the blending sleeve comprises a turbulent structure formed in a peripheral wall of the blending sleeve.

7. The blending sleeve of claim 1, wherein the structure that enables the food processor to blend a set of ingredients inside the blending sleeve comprises a non-stick surface formed inside the blending sleeve.

8. The blending sleeve of claim 1, wherein the structure that enables the food processor to blend a set of ingredients inside the blending sleeve comprises a structure for allowing air to escape from the blending sleeve.

9. The blending sleeve of claim 1, further comprising at least one structure formed in the blending sleeve that facilitates removal of the blending sleeve from the food processor.

10. The blending sleeve of claim 9, wherein the structure that facilitates removal of the blending sleeve from the food processor comprises a pull-tab formed on the blending sleeve.

11. The blending sleeve of claim 9, wherein the structure that facilitates removal of the blending sleeve from the food processor comprises a set of vents formed in a peripheral wall of the blending sleeve.

12. The blending sleeve of claim 1, wherein a peripheral wall of the blending sleeve includes a multiple-wall arrangement.

13. The blending sleeve of claim 1, further comprising an airtight seal formed over a set of freeze-dried ingredients inside the blending sleeve such that the airtight seal provides an open area inside the blending sleeve for accommodating a stack of additional blending sleeves.

14. The blending sleeve of claim 1, further comprising an airtight seal formed over a set of freeze-dried ingredients inside the blending sleeve such that the airtight seal provides an open area inside the blending sleeve for accommodating a set of additional ingredients for blending.

15. The blending sleeve of claim 1, further comprising a set of markings each for indicating a fill level for a corresponding component of the ingredients.

16. A method for providing a blending sleeve for a food processor, comprising:
forming at least one structure of the blending sleeve that enables coupling of the blending sleeve with the food processor; and
forming at least one structure of the blending sleeve that enables the food processor to blend a set of ingredients inside the blending sleeve.

17. The method of claim 16, wherein forming at least one structure of the blending sleeve that enables coupling of the blending sleeve with the food processor comprises forming a lip for providing a seal between the blending sleeve and the food processor.

18. The method of claim 16, wherein forming at least one structure of the blending sleeve that enables coupling of the blending sleeve with the food processor comprises forming an O-ring for providing a seal between the blending sleeve and the food processor.

19. The method of claim 16, wherein forming at least one structure of the blending sleeve that enables coupling of the blending sleeve with the food processor comprises forming at least one structure in a peripheral wall of the blending sleeve for fitting the blending sleeve to a corresponding structure formed in the food processor.

20. The method of claim 16, wherein forming at least one structure of the blending sleeve that enables coupling of the blending sleeve with the food processor comprises forming a set of threads for attaching the blending sleeve to the food processor via a corresponding set of threads of the food processor.

21. The method of claim 16, wherein forming at least one structure of the blending sleeve that enables the food processor to blend a set of ingredients inside the blending sleeve comprises forming a turbulent structure in a peripheral wall of the blending sleeve.

22. The method of claim 16, wherein forming at least one structure of the blending sleeve that enables the food processor to blend a set of ingredients inside the blending sleeve comprises forming a non-stick surface inside the blending sleeve.

23. The method of claim 16, wherein forming at least one structure of the blending sleeve that enables the food processor to blend a set of ingredients inside the blending sleeve comprises forming a structure for allowing air to escape from the blending sleeve.

24. The method of claim 16, further comprising forming at least one structure of the blending sleeve that facilitates removal of the blending sleeve from the food processor.

25. The method of claim 24, wherein forming at least one structure of the blending sleeve that facilitates removal of the blending sleeve from the food processor comprises forming a pull-tab on the blending sleeve.

26. The method of claim 24, wherein forming at least one structure of the blending sleeve that facilitates removal of the blending sleeve from the food processor comprises forming a set of vents in a peripheral wall of the blending sleeve.

27. The method of claim 16, further comprising forming a peripheral wall of the blending sleeve with a multiple-wall arrangement.

28. The method of claim 16, further comprising forming an airtight seal over a set of freeze-dried ingredients inside the blending sleeve such that the airtight seal provides an open area inside the blending sleeve for accommodating a stack of additional blending sleeves.

29. The method of claim 16, further comprising forming an airtight seal over a set of freeze-dried ingredients inside the blending sleeve such that the airtight seal provides an open area inside the blending sleeve for accommodating a set of additional ingredients for blending.

30. The method of claim 16, further comprising forming a set of markings on the blending sleeve each for indicating a fill level for a corresponding component of the ingredients.
